(19) United States
(12) Patent Application Publication
(10) Pub. No.: US 2010/0269867 A1
(43) Pub. Date: Oct. 28, 2010

(54) WATER-BEARING DOMESTIC APPLIANCE

(75) Inventors: Johannes Büsing, Emersacker (DE); Gerhard Fetzer, Gundelfingen (DE); Hubert Groll, Modingen (DE); Roland Rieger, Rainau (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERATE GMBH, Munich (DE)

(21) Appl. No.: 12/743,241

(22) PCT Filed: Oct. 28, 2008
(86) PCT No.: PCT/EP2008/064576

§ 371 Date: May 17, 2010

(30) Foreign Application Priority Data
Nov. 27, 2007 (DE) 10 2007 056 919.1

(51) Int. Cl. B08B 3/14

(52) U.S. Cl. 134/104.4

(57) ABSTRACT

A water-bearing domestic appliance, in particular a dishwasher or washing machine. The appliance may include a hydraulic circuit and a stationary screening apparatus which has a screening face, which is arranged in the hydraulic circuit, for filtering recirculated washing water. In an exemplary embodiment of the invention, the screening face is formed so as to generate transverse flows which are directed transverse to the passage-flow direction of the screening face.

The invention relates to a water-bearing domestic appliance in accordance with the preamble of claim 1.

Water-bearing domestic appliances, such as dishwashers or washing machines for example, have a screening system which can comprise a number of stages and which is used to free washing liquor recirculated during operation from contamination particles which could otherwise cause residual soiling. If contamination levels are too high however the screening system can become blocked and lose its effect, since then contaminated washing liquor is recirculated unfiltered via a bypass.

A water-bearing domestic appliance having a self-cleaning filter system is known from DE 41 31 914 C2. One of the features of the self-cleaning filter system is an axially-rotatable screening insert of which the outer surface extends conically downwards. Contaminants adhering to its inner side are pushed downwards by centrifugal force into a contaminant-catching chamber until they are removed during an emptying process.

The object of the present invention is to specify a water-bearing domestic appliance with a filtering or screening apparatus which has a simple construction and operates reliably even at high contaminant levels and thus prevents residual contamination.

The invention is based on a water-bearing domestic appliance, especially a dishwasher or washing machine, at least having a hydraulic circuit and a screening apparatus having a screening face permanently arranged in the hydraulic circuit for filtering recirculated washing water. In this device the screening face is able to be cleaned by backflushing it. Other methods or apparatuses for cleaning the screening face can be used however to remove a filter cake.

The object of the invention is achieved by the screening face being formed so as to generate transverse flows which are directed transverse to the passage flow direction of the screening face, so that the transverse flow has the effect of collecting held-back particles in selected areas while other areas remain free of accumulated particles and thus the screening/filter system remains operable. The screening system can be cleaned by a backflushing device, in which the washing liquor flows through the screening system in the opposite direction to the direction of flow.

In order to facilitate the loosening of adhering contamination particles in such cases and to effect this type of transverse flow, the screening face is preferably embodied with raised sections or indentations. This gives the screening face sections of which the height is below that of the remaining screening face. The contamination particles preferably collect in these indentations. The result of this is that on the one hand the higher areas of the screening face remain free and allow the unimpeded passage of the water to be filtered. A minimum passage cross section of the screening apparatus is thus retained. On the other hand the contaminant particles preferably collect in the indentations and attach themselves there. In this concentrated form they are able to be more easily removed during backflushing. This means that such a screening apparatus can in the ideal case remain maintenance-free throughout its life.

The inventive form of the screening face can be achieved in a flat embodiment by forming dish-shaped indentations for example. The floor surfaces of the indentations then form a height level sunken in relation to the remaining height of the screening face. Alternatively the screening face can feature both these types of indentations and also comparable protruberances or raised sections in the opposite direction. If they are close together the original horizontal screening plane can be completely broken up so that horizontal sections are only present on the floor surfaces of the indentations and on the top surfaces of the protruberances. A significant effect of these embodiments of the screening face is also that their effective surface is significantly enlarged within the same space. Compared to conventionally-designed screening apparatuses, a larger effective passage surface for recirculated rinsing water is thus essentially available in the screening apparatus with the same space requirement.

A throughflow direction at the screening apparatus is the predominant flow direction of the rinsing water directly through the screening face during a rinsing process.

An inflow direction of the screening apparatus is the flow direction of the rinsing water on entry into the screening apparatus. With a flat screening face it can essentially run in parallel to the throughflow direction and at right angles to the screening face. When the screening apparatus is cleaned by backflushing, water is sucked through the screen against the throughflow direction or through the screening apparatus against the inflow direction or the direction of flow is reversed.

The screening face can basically extend over a surface in one plane. In accordance with a preferred embodiment of the invention the screening face can however be arranged in the form of a cylinder or in the form of a cone. If for example it forms the outer surface of a cylinder, the screening apparatus can be used in dishwashers even within restricted spaces without reducing the effective screening face in this configuration. A further advantage of these forms is an increased inherent stability of the screening apparatus. Reinforcement elements can then largely be dispensed with. In these embodiments the inflow direction of the screening apparatus and the throughflow direction of the screening face are essentially at right angles to each other. This is because the inflow into the screening apparatus is then generally from one of its circular top faces, i.e. axially, the water is diverted and then flows radially through the screening face. Since it can be cleaned by backflushing, the screening apparatus can be arranged to prevent it rotating.

The shape of the indentations and/or protruberances and their arrangement on the screening face can basically and in respect of their function have almost any design. In accordance with a further advantageous embodiment of the invention the indentations and/or protruberances can be repeated in a regular sequence.

Preferably the transitions in such cases are embodied as seamless transitions, typically having an undulating contour. The shape of the undulations in this case is not restricted to a regular, especially sinusoidal curve. It can be described by the shape and alignment of the undulation peaks and undulation troughs. The maximum elevation of the undulation peaks and the bottoms of the undulation troughs are referred to as vertexes. With a linear progression of undulation peaks or undulation troughs a vertex line of an undulation peak or of an undulation trough respectively is produced. By contrast circular vertex lines of the undulation troughs can also be arranged around a point-type vertex of an undulation peak or undulation peaks as pips alternating with inversely shaped undulation troughs on the screening face.

In a further advantageous embodiment of the invention the size of the undulations can vary in the inflow direction, for example the height of the undulation peaks or the depth of the undulation troughs can increase in the inflow direction. With a decreasing height of the undulation peaks or depth of the undulation troughs in the inflow direction larger contamination particles can be filtered out first and smaller contamination particles at the end of the screening apparatus. With a sufficient length of the screening apparatus in the inflow direction this allows a corresponding distribution of the particle size, with the passage behavior of the overall screening apparatus remaining just as good.

With rotationally-symmetrical screening apparatus shapes, such as cylinder shapes or cone shapes for example the inflow direction corresponds to the axis of rotation of the screening apparatus. This enables an especially simple and low-cost structure to be achieved. Basically the vertex lines of the undulations can be arranged at any given angle to the inflow direction. An arrangement of the vertex lines in parallel to the inflow direction or at right angles thereto is useful. In a further advantageous embodiment of the invention the screening face is formed from undulations arranged in parallel to each other and to the inflow direction with straight-line vertex lines. This enables water to be screened to be applied to the screening face as evenly as possible.

Since the screening apparatus does not have to move during operation, asymmetrical screening apparatus shapes can also be realized. This can be of advantage, especially where space is restricted. In the area of the pump sump of dishwasher for example there is frequently very little installation space available.

Fibers or threads made of plastic or wires made of metal can be used for example as the screening material, which are connected to one another by a suitable techniques such as spinning, weaving or knitting for example. With such woven materials the holes correspond to the mesh widths. Depending on the connection technique, the form and size of the meshes can vary. For reasons of simple and low-cost manufacturing a perforated metal sheet is preferably used as a screening material. In a further preferred embodiment the screening face has holes with different hole geometry. Depending on the material as well as the material thickness of the screening face different hole geometries are already produced.

Since the present apparatus involves a microscreen, fine metal sheets with a small thickness are preferably used in which the holes are typically made by a laser processing method. Here too the geometry of the holes can in principle be freely selected. Circular holes are the easiest to produce and thereby cost-effective.

In a further embodiment of the invention the holes narrow conically. Preferably they narrow against their direction of throughflow. Particles which have passed through a hole at its narrowest opening as a rule no longer remain stuck in the following area. If on the other hand particles remain stuck at the hole they only adhere on the inflow side to the surface. This enables a wedging of particles to be countered and a release of any particles which may have become wedged to be assisted during backflushing.

In a further advantageous embodiment of the invention the screening face has a varying hole density in the inflow direction. This explicitly enables different throughflow resistances to be created at the screening face which bring about a defined particle distribution. Thus, especially with uneven inflow conditions of asymmetrical screening apparatuses, this makes sure that there is a largely even application to the screening face, which ensures trouble-free functioning of the screening device.

The principle of the invention will be explained in greater detail below by way of example, with reference to schematic diagrams of an embodiment. The figures show:

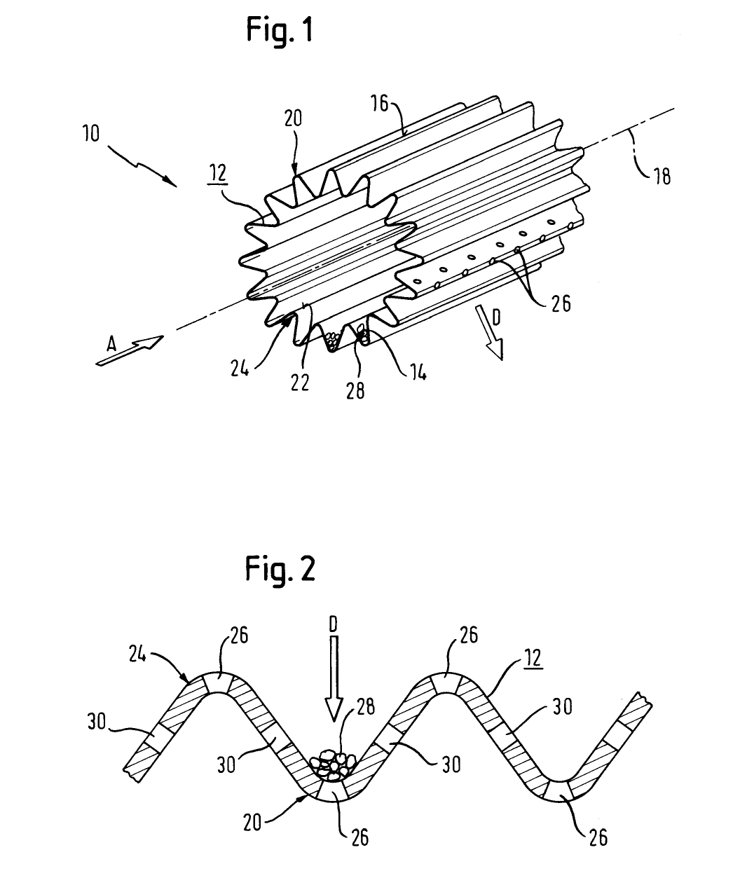

FIG. 1 a perspective part view of a cylindrical screening apparatus with an undulating screening face, and

FIG. 2 a greatly enlarged cross-sectional view of the screening face.

FIG. 1 shows a cylindrical screening apparatus 10 with an undulating screening face 12. The undulating screening face forms the outer surface of the screening apparatus 10. It is formed from a number of undulations 14, the vertex lines 16 of which run in parallel both to each other and also to the longitudinal axis 18 of the screening apparatus 10. The vertex lines 16 define the maximum radial extension of the screening face 12 in relation to the longitudinal axis 18. This area is referred to as the undulation trough 20. The screening apparatus 10 also has vertex lines 22 which run in relation to the vertex lines 16 at a smaller radial distance from the longitudinal axis 18. They identify the tip of an undulation peak 24 of the undulating screening face 12.

During a washing process the washing water is pumped along an inflow direction A in parallel to the longitudinal axis 18 into the inside of the fixed apparatus 10. The screening apparatus 10 is preferably installed horizontally in the dishwashing machine, but it can however also be installed aligned vertically for example. During operation the washing water flows through the screening apparatus 10 from inside outwards through the undulating screening face 12 in a throughflow direction D. To this end the undulating screening face 12 features a number of holes 26, which are merely shown by way of example for one undulation 14 in FIG. 1.

During the flow through the screening face 12 the contamination particles 28 accumulate in the area of the undulation troughs 20. Because they concentrate in the undulation troughs, they are compressed there into larger lumps. At the same time the areas of the undulation peaks 24 remain free from particles and thereby guarantee a further throughflow of the rinsing water.

The screening apparatus 10 is cleaned by a backflushing process in which the direction of flow is reversed. Water then flows against the throughflow direction D through the screening face 12 and in doing so releases particles 28 collected in the undulation troughs 20 which are then washed out of the screening apparatus 10 again against the inflow direction A. The collected contamination particles are released in this process in the form of lumps. The screening apparatus 10 is given a very good self-cleaning effect by this.

FIG. 2 provides an enlarged cross-sectional view through an area of the undulating screening face 12. The holes 26 in the area of the undulation peaks 24 and the undulation troughs 20 are formed into a slightly spherical or conical shape here. This hole geometry can be produced at the stage of manufacturing the undulating screening face 12. The screening face is manufactured from a sheet of metal into which the holes 26 are first made and which only then is made into an undulating shape. In such cases the holes widen out in a corresponding conical shape in the area of the undulation peaks 24 against the throughflow direction and those of the undulation troughs 20 in the throughflow direction. At the same time a number of holes 30 in the transition areas between undulation trough 20 and undulation peak 24 remain in an unchanged cylindrical shape. This different hole geometry affects the throughflow behavior of the undulating screening face 12. This is because the narrowing holes in the area of the undulation peaks 24 cause a greater throughflow resistance. Conversely a lower resistance is presented to the water at the widening holes 26 in the area of the undulation troughs. When the rinsing water flows into the rinsing face 12 in the throughflow direction D, the contamination particles initially collect in the areas with low throughflow resistance. This causes the throughflow resistance at these points to increase. At the same time the availability of the holes 26 in the remaining areas remains unchanged, thus continuing to guarantee a sufficient throughflow cross section for the water. They can also not be covered so quickly by particles since the particles can barely hold onto the edges and the vertex of the undulation peaks 24. The hole geometry of the holes 26 thus assists the particle concentration in the undulation troughs. In addition the spherical holes 26 of the undulation troughs 20 act during the backflushing process as nozzles and support the release of the particles 28 on them.

### LIST OF REFERENCE SIGNS

10 Screening apparatus
12 Undulating screening face
14 Undulation
16, 22 Vertex line
18 Longitudinal axis of the screening apparatus
20 Undulation trough
24 Undulation peak
26, 30 Hole
28 Contamination particle
A Inflow direction
D Throughflow direction

1-10. (canceled)

11. A water-bearing domestic appliance, comprising:
a hydraulic circuit; and
a screening apparatus including a screening face arranged in the hydraulic circuit and structured to filter recirculated rinsing water, wherein the screening face is operable to create transverse currents directed transversely to a throughflow direction of the screening face.

12. The water-bearing domestic appliance as claimed in claim 11, wherein the screening face includes at least one of raised sections and indentations extending in the throughflow direction.

13. The water-bearing domestic appliance as claimed in claim 11, wherein the screening face is shaped as at least one of a cylinder and a conical outer surface.

14. The water-bearing domestic appliance as claimed in claim 12, wherein the at least one of raised sections and indentations of the screening face include seamless transitions as undulations.

15. The water-bearing domestic appliance as claimed in claim 14, wherein the undulations run in parallel to one another.

16. The water-bearing domestic appliance as claimed in claim 14, wherein vertex lines of the undulations run in parallel to an inflow direction of the screening face.

17. The water-bearing domestic appliance as claimed in claim 11, wherein the screening face includes a plurality of holes with differing hole geometries.

18. The water-bearing domestic appliance as claimed in claim 17, wherein the holes narrow conically.

19. The water-bearing domestic appliance as claimed in claim 17, wherein a hole density of the screening face varies in an inflow direction.

20. The water-bearing domestic appliance as claimed claim 11, wherein the screening face is structured to be cleaned by backflushing.
